(19) United States
(12) Patent Application Publication
(10) Pub. No.: US 2009/0288715 A1
(43) Pub. Date: Nov. 26, 2009

(54) HOT WATER RECIRCULATOR USING PIPING VENTURI

(76) Inventor: Gregory Michael Granger, SR., Hemet, CA (US)

Correspondence Address: BUHLER ASSOCIATES;BUHLER, KIRK A., 1101 CALIFORNIA AVE., SUITE 208, CORONA, CA, 92881, US

(21) Appl. No.: 12/435,803

(22) Filed: May 5, 2009

Related U.S. Application Data
(60) Provisional application No. 61/054,715, filed on May 20, 2008.

(51) Int. Cl. F16L 53/00

(52) U.S. Cl. 137/337

(57) ABSTRACT

Improvements in a hot water circulator are disclosed. The hot water circulator is placed in proximity to one or more water faucets or tubs. The construction of the hot water circulator creates a venture in the cold water line. When a user turns on the cold water the flow of cold water through the cold water line draws a portion of water from the water heater through the hot water line and into the cold water line. Because only a small portion of water is being drawn into the cold water line the temperature difference is negligible, but the hot water is brought to close proximity to the hot water valve where it is more quickly available. There is a reduced amount of water being wasted to bring hot water to the hot water valve. Hot water is delivered in seconds rather than minutes.

### CROSS REFERENCE TO RELATED APPLICATION

This application claims the benefit of Provisional 61/054,715 filed May 20, 2008 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates to improvements in a hot water recirculator. More specifically the improvement includes a venturi type pipe arrangement where hot water is drawn though the plumbing to circulate hot water in a house when a user runs cold water.

2. Description of Related Art Including Information Disclosed Under 37 CFR 1.97 and 1.98

Several products and patents have been issued for hot water circulators. The majority of these patents use a powered pump that is powered with electricity to draw water from the hot water and pumping the hot water into the cold water line. Other patents use an aspirator and a check valve to move hot water to the hot water valve without a motor. Exemplary examples of patents covering these products are disclosed herein.

U.S. Pat. No. 7,178,543 issued Feb. 20, 2007 to Charles L. Adams discloses a motorized Thermostatically Controlled Bypass Valve. The motor operates when the temperature within the pipe reaches a pre-defined low temperature. At this temperature the motor will operate to move hot water from the hot water tank through the hot water lines of the house and into back into the hot water tank. While no water is wasted by the use of this system, the system will turn on and off at various times of the day to maintain hot water within the hot water lines. This invention also requires that the home be built with a return line from one or more of the farthest water demand units back to the water tank.

U.S. Pat. No. 7,475,703 issued Jan. 13, 2009 to Dale Kempf discloses a motorized Rapid Hot Water Apparatus and Method. The motor operates at preset times, time intervals or when a user presses a remote button. Water will continue to circulate through the pipes until the desired temperature is achieved. When the temperature within the pipe reaches a pre-defined low temperature. The motor will operate to move hot water from the hot water tank through the hot water lines of the house and into back into the hot water tank. While no water is wasted by the use of this system, the system will turn on and off at various times of the day to maintain hot water within the hot water lines. This invention also requires that the home be built with a return line from one or more of the farthest water demand units back to the water tank.

U.S. Pat. No. 5,518,022 issued May 21, 1996, U.S. Pat. No. 5,918,625 issued Jul. 6, 1999 and U.S. Pat. No. 6,161,567 issued Dec. 19, 2000, all to Raymond G. Ziehm disclose water circulators of various configurations where the Aspirator Water Circulation Apparatus an Integral Water Circulation Apparatus and a Single Chamber Water Circulator respectively. These patents require a return line from one or more of the furthest water faucets to return hot water back to the do not.

What is needed is a simple hot water recirculator that can be placed within an existing house or building. The ideal hot water recirculator would not require any electricity to operate and include components that are easy to service. The hot water recirculator disclosed in this application provides that solution.

### BRIEF SUMMARY OF THE INVENTION

It is an object of the hot water recirculator using a piping venturi to circulate hot water throughout entire system through a series of valves that results in a completely green system.

It is an object of the hot water recirculator using a piping venturi using a series of component such as a ball valve, pressure regulator, swing check valve. These components should be assembled as one unit where they can be installed as a single integral unit.

It is an object of the hot water recirculator using a piping venturi that does not require an electrical connection to power a motor to move water through the plumbing system of a house or building. The recirculator uses flow through the cold water pipes to draw a small amount of water through the hot water pipes to make hot water more radially available.

It is an object of the hot water recirculator using a piping venturi to not waste hot water from a user running the hot water faucet until hot water is available. The Depending upon the distance between the hot water tank and the faucet two to three gallons or more of water will pour down a drain until hot water is available.

It is another object of the hot water recirculator using a piping venturi for hot water to be more quickly available at a faucet. The faster availability of hot water reduces water waste and the time a person will wait until the hot water is available. If a person turns on a faucet or shower and then waits they may not immediately use the water as they perform other tasks waiting for the water to become hot. This results in not only a waste of cold water but also heated water.

It is still another object of the hot water recirculator using a piping venturi that it can operate without a return line. Using the venturi to draw a small amount of water through the hot water line allows a user to actually use the cold water through the day while at the same time they are making maintaining hot water in closer proximity to the faucets.

It is still another object of the hot water recirculator using a piping venturi to utilize the pressure drop in the water lines that are being used to draw water through the pipes. When cold water is being used there is a drop in the cold pressure line while the pressure in the hot water line remains higher than the cold water line. This reduction of pressure in the cold water line allows some water from the hot water line to be drawn into the cold water line to make hot water more quickly available.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a block diagram of the recirculator in a house plumbing system.

FIG. 2 shows a plan view of a first preferred embodiment showing a multi-stage recirculator.

FIG. 3 shows a plan view of a second preferred embodiment.

FIG. 4 shows an end view of the second preferred embodiment.

FIG. 5 shows a block diagram of the recirculator in a house plumbing system without a return line.

FIG. 6 shows a perspective view of a third preferred embodiment.

FIG. 7 shows a plan view of the third preferred embodiment.

FIG. 8 shows an end view of the third preferred embodiment.

### DETAILED DESCRIPTION OF THE INVENTION

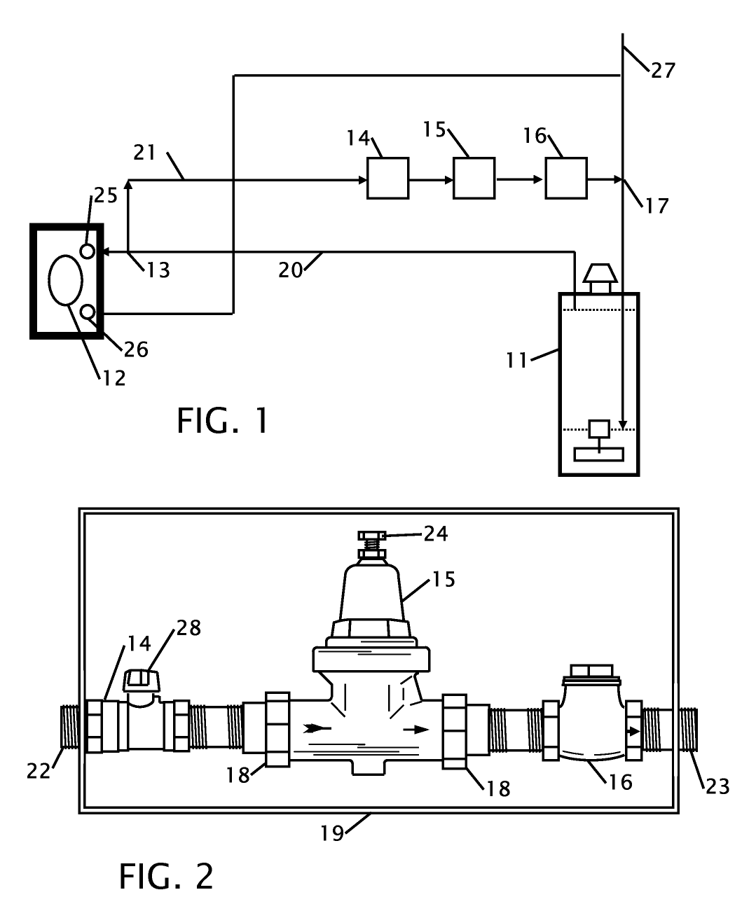

FIG. 1 shows a block diagram of the recirculator in a house plumbing system. In general, the installation starts from the furthest point on the hot water system or the water dispensing location 12 where water is brought back to the closest point entering the cold side of water heater through a Tee 17 with a series of valves 14, 15 and 16 that make-up the regulator. This recirculator has can be installed and tested in several homes and has been proven to provide beneficial results. A tee 13 branches from the hot water supply line 20 to the hot water recirculator.

In the first preferred embodiment the multi-stage hot water recirculator has three stages of a water recirculator including but not limited to a shut-off valve 14 the shut off valve is preferably a ball valve but other types of valves are contemplated that will provide the function of shutting off or allowing water to flow through the apparatus. FIG. 2 shows a plan view of a first preferred embodiment showing a multi-stage recirculator.

Another stage of the three stages of said water recirculator is a pressure regulator valve 15. The pressure regulator limits the amount of pressure that flows through the recirculator. The regulator is essentially a spring loaded valve wherein when the pressure exceeds a preset limit the pressure valve will open to allow flow through the valve. The amount of pressure required to open the spring is adjustable using the nut, bolt or screw 24 located on top of the pressure regulator 15 (shown in FIG. 2). The third stage of the recirculator is a swing valve or spring valve 16. The swing valve or spring valve 16 inhibits water (cold water) from flowing back into the hot water supply. These three stages are configured in a serial arrangement in close proximity to the hot water heater 11. While these three stages are shown and described in a particular order, the order of the three components can vary with minimal or no effect on the operation of the device.

A water or hot water return line 21 is connected from a water supply valve 25 to the three stage water recirculator. This hot water return line 21 is location in close proximity to where a cold water supply or Tee 17 is connected into a hot water heater, whereby when water is flowing through a cold water pipe 26 supplying water to said cold water supply 27, some water is drawn from a hot water supply pipe 20 to the water return line 21.

In the preferred embodiment all of the stages of the multi-stage hot water recirculator are enclosed in a housing 19 as shown in FIG. 2. For ideal operation the multi-stage hot water recirculator is located in close proximity the hot water heater within ten feet of said hot water heater. The ideal distance is within several inches or feet of the hot water heater, but this distance should not exceed five to ten feet. If the distance is too great then the pressure reduction that allows water to flow through the recirculator is insufficient to open the pressure regulator and or one-way valve and the system does not operate acceptably.

Some of the three stages are preferably connected with unions 18 to allow for servicing or replacement of the components. From FIG. 2 a control knob 28 is shown on top of valve 14. The control knob 28 is used to open or close flow through the recirculator. An inlet 22 is connected to the hot water return (21 in FIG. 1). An outlet 23 is connected to the tee (17 in FIG. 1).

Installation includes starting from the furthest fixture a pipe of any size or type must be run direct to the cold side of water heater where the ball valve which installed for isolation so any component can be serviced or replaced without shutting down entire water system pressure regulator this controls the amount of desired water pressure to keep the final component from hammering the last part of the device is the check valve this acts as a one way door between the cold water and hot water. The check valve can be a variety of types including but not limited to a ball type, flapper type, fluid controls, thermoplastic, diaphragm or elastomeric type check valve. The return line must be thoroughly insulated for added efficiency. To reduce water hammer, a water hammer arrestor can be installed inline before the adjustable pressure regulating valve 15.

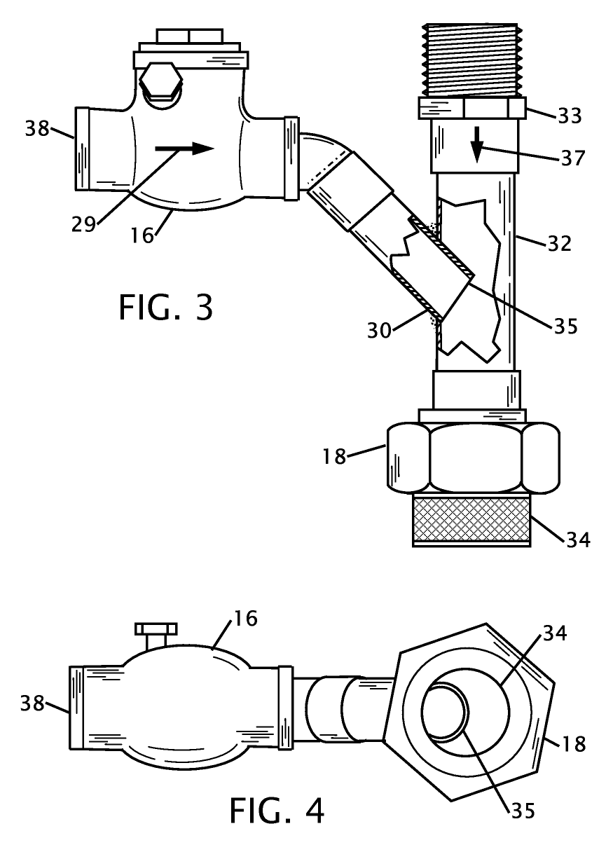

FIG. 3 shows a plan view of a second preferred embodiment. FIG. 4 shows an end view of the second preferred embodiment. FIG. 6 shows a perspective view of a second preferred embodiment. In this embodiment the recirculator is simplified with a through pipe 32 having an inlet 33 and an outlet 34. The inlet and or the outlet can have a union coupling 18 to help facilitate installation. The through pipe 32 further has a side port 30 where the side port 30 enters into the through pipe 32 at an angle. The side port extends into and terminates within the through pipe 32. When water flows from the water inlet 33 to the water outlet 34, water is drawn through the side port 30 and out the water outlet 34.

The angle that the side port 30 enters the through pipe 32 is preferably between 30 and 60 degrees with the though pipe 32. The angle allows the side port 30 to extend into the through pipe 32 to create a venturi to draw water through the side port. While prototypes have been made where the side port 30 enters the through pipe 32 at a 45 degree angle angles between 30 and 60 degrees will perform acceptably. In the cut-away view from FIG. 3 the side port 30 is shown extending into 35 the through pipe 32. In this embodiment the side port 30 extends into the through pipe 32 between 25 to 50 percent of the through pipe 32. This amount does not appreciably decrease the amount of flow through the through pipe 32, but creates sufficient suction on the side port 30 to draw water through the side port 30. The ports and or pipes can include indicia 29 and 37 to identify the connections or flow directions through the recirculator.

The hot water recirculator can optionally include a check valve 16 that is a swing valve or spring valve. The check valve can be a variety of types including but not limited to a ball type, flapper type, fluid controls, thermoplastic, diaphragm or elastomeric type check valve. The check valve 16 has an inlet 38 for connection with a hot water supply line.

The hot water recirculator is preferably made from copper, brass where the components are soldered 36 together. It is also contemplated that the hot water recirculator is made from a casting or molded process provided the function remains essentially the same.

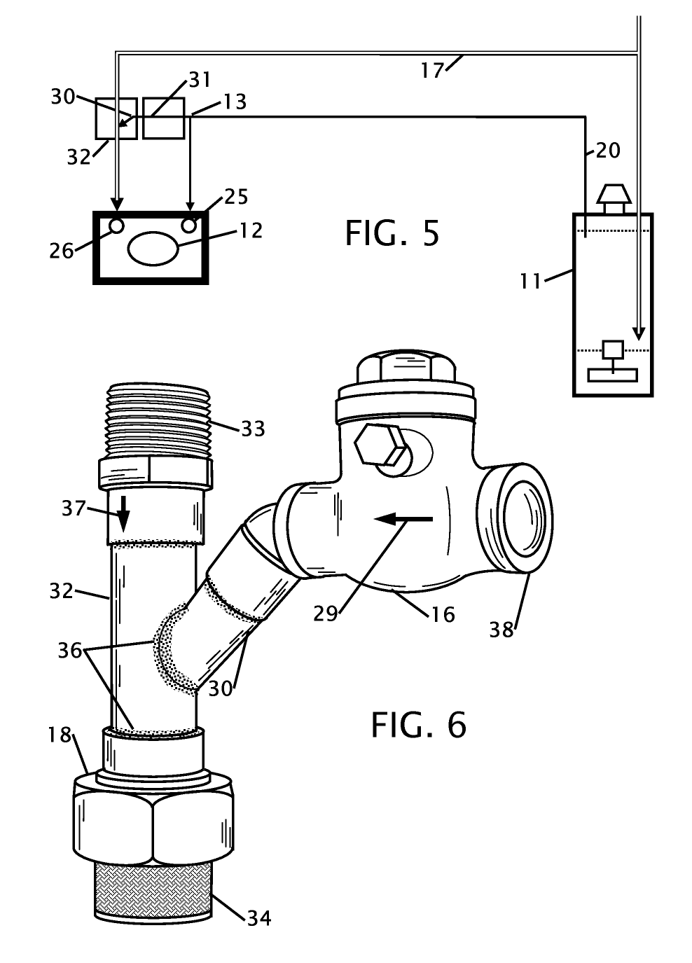

FIG. 5 shows a block diagram of the recirculator in a house plumbing system without a return line. This configuration uses the hot water heater 11 and the existing hot water supply line 20 and the existing cold water supply line 17. The recirculator is connecting said inlet to a cold water supply 17 in placed in proximity to a hot 26 and cold 27 water dispensing location 12 with a hot water supply valve 25 and a cold water supply valve 26. The recirculator is connected to the outlet to a valve to the water dispensing location 12. A tee 13 connects the hot water inlet 31 side port 30 where it exits into the through pipe 32.

When cold water is being used a portion of hot water is being drawn from the hot water tank to make the hot water more available to both the water dispensing location and to any additional water dispensing location located between the hot water tank and the dispensing location that is using cold water.

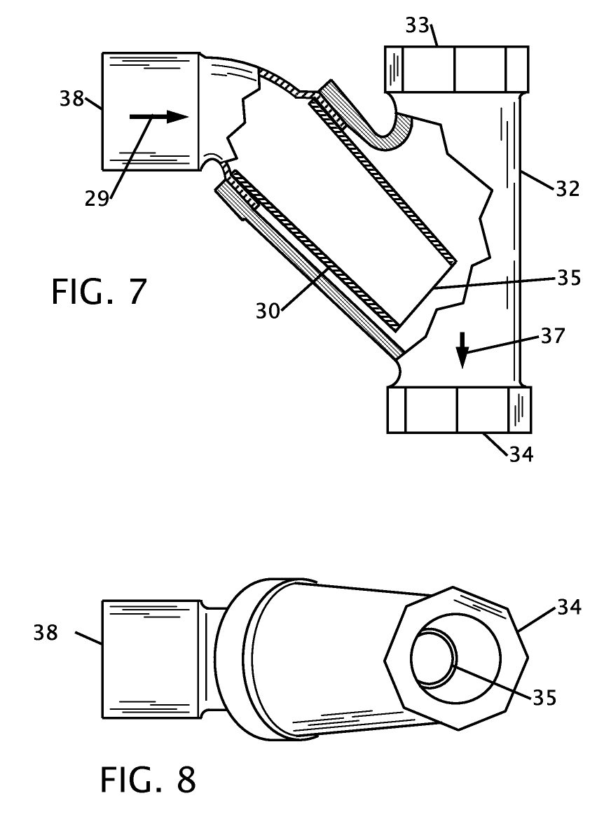

FIG. 7 shows a plan view of the third preferred embodiment. FIG. 8 shows an end view of the third preferred embodiment. This embodiment is the simplest configuration with a through pipe 32 having an inlet 33 and an outlet 34. The side port 30 starts from an inlet 38 where it terminates 35 within the through pipe 32. The ports and or pipes can include indicia 29 and 37 to identify the connections or flow directions through the recirculator.

When this system is installed correctly these three components will allow hot water to be mixed with the cold water entering the water heater and pre-heating the water and creating circulation. This system can be used in many applications from households, commercial, hotels, and multi-family units.

Thus, specific embodiments of a hot water recirculator using a piping venturi have been disclosed. It should be apparent, however, to those skilled in the art that many more modifications besides those described are possible without departing from the inventive concepts herein. The inventive subject matter, therefore, is not to be restricted except in the spirit of the appended claims.

1. A multi-stage hot water recirculator comprising:
one of a three stages of a water recirculator is a shut-off valve;
one of three stages of said water recirculator is a pressure regulator valve;
one of three stages of said water recirculator is a swing valve or spring valve;
said three stages are arranged in a serial arrangement;
a water return line connected from a water supply valve to said three stage water recirculator to a location in close proximity to where a cold water supply is connected into a hot water heater, whereby
when water is flowing through a cold water pipe supplying water to said cold water supply, some water is drawn from a hot water supply pipe to said water return line.

2. The multi-stage hot water recirculator according to claim 1 wherein said three stages are placed in the order of said shut-off valve said pressure regulator and then said swing valve or spring valve.

3. The multi-stage hot water recirculator according to claim 1 wherein said three stages are placed in the order of said shut-off valve, said swing valve or spring valve and then said pressure regulator.

4. The multi-stage hot water recirculator according to claim 1 wherein said three stages are placed in the order of said pressure regulator said shut-off valve and then said swing valve or spring valve.

5. The multi-stage hot water recirculator according to claim 1 wherein said three stages are placed in the order of said pressure regulator, said swing valve or spring valve and then said shut-off valve.

6. The multi-stage hot water recirculator according to claim 1 wherein said three stages further include coupling joints between each of said three stage.

7. The multi-stage hot water recirculator according to claim 1 wherein all of said three stages are enclosed in housing.

8. The multi-stage hot water recirculator according to claim 7 wherein said housing is located within ten feet of said hot water heater.

9. A hot water recirculator comprising:
a through pipe with an inlet and an outlet;
said through pipe further having a side port wherein said side port enters into said through pipe at an angle;
said side port extends into and terminates within said through pipe whereby,
when water flows from said inlet to said outlet water is drawn through said side port and out said outlet;
a water return line connected from a water supply to said side port to a location in close proximity to where a cold water supply is connected into a hot water heater, whereby
when water is flowing through a cold water pipe supplying water to said water supply valve, some water is drawn from a hot water supply pipe to said water return line.

10. The hot water recirculator according to claim 9 that further includes a check valve.

11. The hot water recirculator according to claim 9 that is made from metal and or plastic components.

12. The hot water recirculator according to claim 9 wherein said side port extends into through pipe between 25 and 50 percent.

13. The hot water recirculator according to claim 9 wherein said side port enters said through pipe at an angle of between 30 and 60 degrees with said through pipe.

14. A hot water recirculator comprising:
a through pipe with an inlet and an outlet;
said through pipe further having a side port wherein said side port enters into said through pipe with at an angle;
said side port terminates within said through pipe whereby,
when water flows from said inlet to said outlet water is drawn through said side port and out said outlet;
connecting said inlet to a cold water supply in placed in proximity to a hot and cold water dispensing location;
connecting said outlet to a valve to said water dispensing location;
connecting said side port to said hot water supply of said dispensing location;
whereby when water is flowing through from said inlet to said outlet some water is drawn from a hot water supply pipe to said water return line.

15. The hot water recirculator according to claim 14 that further includes a check valve.

16. The hot water recirculator according to claim 15 wherein said check valve is a swing valve.

17. The hot water recirculator according to claim 15 wherein said check valve is a spring valve.

18. The hot water recirculator according to claim 14 wherein said side port extends into through pipe between 25 and 50 percent.

19. The hot water recirculator according to claim 14 wherein said side port enters said through pipe at an angle of between 30 and 60 degrees with said through pipe.

20. The hot water recirculator according to claim 14 that is made from metal and or plastic components.
